(19) United States
(12) Patent Application Publication
(10) Pub. No.: US 2009/0211563 A1
(43) Pub. Date: Aug. 27, 2009

(54) Open fire, multi-purpose cooking grill

(76) Inventors: Robin Blackshear, Mt. Belvieu, TX (US); Walter W. Blackshear, JR., Baytown, TX (US)

Correspondence Address: Robin Blackshear, P.O. Box 1754, Mt. Belvieu, TX, 77580, US

(21) Appl. No.: 12/072,099

(22) Filed: Feb. 25, 2008

(51) Int. Cl. A47J 37/00; A47J 37/07

(52) U.S. Cl. 126/30; 126/25 R

(57) ABSTRACT

An open fire multipurpose cooking grill generally comprising a metal “T” shaped stake that can be optionally driven into the ground or placed into a base stand holder in positioned near a campfire, patio fire-bowl, fire-ring, or charcoal container for cooking and tending to food, generally outdoors. The cooking grill having attached to it multiple bracket sleeves allowing for quick and easy installation and removal of multiple cooking grills and food preparation trays which can be raised and lowered and swiveled side to side closer to or further from the fire as needed.

### BACKGROUND OF THE INVENTION

1. Field of the Invention

The present invention relates to a cooking grill, and more specifically, a multi-purpose cooking grill, which can be used to cook over an open fire, camp fire, or fire-bowl with multiple, removable, and adjustable cooking grills and food preparation trays.

2. Description of Related Art

Cooking over open fires has long been enjoyed and many different types of cooking grills have been used.

One common way of accomplishing this type of cooking is to have a grill or surface on which to place food to be cooked and have it supported by some means so that the food will be in position over a fire at the proper height. In order to cook the food properly, several devices of this general type have been disclosed in the prior art. These have included devices, which have horizontally positioned grills or surfaces on which to place food to be cooked supported by a vertical stake, which can be placed near the fire so that the food can be appropriately positioned over the fire for cooking.

However, none of the prior art discloses a cooking grill having multiple, removable grills and/or adjustable trays along the front surface of the vertical stake.

Nor do they disclose a perpendicular, top horizontal support, to attach additional removable grills and/or trays used in the handling, preparation, and cooking of food.

Furthermore, while afore mentioned prior art includes an array of cooking grills that fulfill their respective particular objective and requirements, they do not disclose a new and unique open fire, multi-purpose cooking grill and none of the above patents or inventions taken either singly or in combination is seen to describe the present invention as claimed.

References to Prior Art:

| U.S. Pat. Nos.: | Inventor | Date |
|---|---|---|
| 6,105,569 | Andrews | Aug. 22, 2000 |
| 6,006,740 | Ulrichson | Dec. 28, 1998 |
| 4,351,312 | Ivy | September 1982 |

And U.S. Pat. Nos. 5,660,940; 2,977,953; 5,287,844; 4,607,608

### SUMMARY OF THE INVENTION

The present invention relates to a cooking grill, which is useful in cooking food over open fires including, but not limited to campfires, fire pits, patio fire basins, fire rings, and other such open fires. The cooking grill generally comprises a vertical support stake, which can be driven into the ground, or optionally be placed into a base holder near an open fire container, or campfire. The vertical stake, which is made from metal to ensure strength and durability, consists of a horizontal top portion perpendicular to, and on top of the vertical stake, and permanently affixed thereto.

The horizontal top portion of the cooking grill support stand, is positioned on top of said vertical stake and extends outwardly and has on each end a female holder sleeve with which to hold a grill and/or tray in the food preparation and cooking process.

The vertical part of the cooking grill support stand hereinafter referred to as “vertical stake” consists of a metal rod or metal tubing with a top and bottom. The top portion, the vertical stake, has affixed to it the horizontal piece, previously described, and together form the shape of a “T.” The bottom of the vertical stake is cut at an angle so as to present a sharp edge for penetration into the ground. Also, the bottom end of the vertical stake is shaped and formed to fit into a base stand for use in situations where it is not possible to drive the stake into the ground, ie. For use on a hard surface, concrete patio, brick or stone surface where a patio fire bowl or firebox may be used.

In addition, the vertical stake has a front, rear, right, and left side. The front side of the vertical stake has affixed to it multiple female holding sleeves along its length from top to bottom spaced sufficiently apart to allow one or more cooking grills and/or trays to be held in a position over the fire as the food upon said grill and/or tray is being cooked by the fire beneath it. The bracket sleeves are permanently affixed to the vertical stake in a manner parallel to the vertical stake and are cylindrical in shape having a top and bottom and a hole traversing through said bracket from top to bottom. The various spacing and positioning of said bracket sleeves along the front edge of the vertical stake allow for the cooking grill and/or tray to be raised and lowered to the desired distance above the fire to control the amount of heat exposure to the food being cooked. Placing the cooking grill/tray in a lower position closer to the fire will provide more heat to the food on the grill/tray while raising the grill to a higher position on the vertical stake will increase the distance from the fire below and expose the food to less heat if desired.

Another feature of the open fire, multi-purpose cooking grill are the grills and/or trays, which provide the surface on which to place food and cookware while cooking over the fire. Said grill consists of a flat, square or rectangular shaped surface comprised of a metal grate sufficient to hold cookware and food while being cooked over the fire. The grill/tray has around its outer perimeter a raised lip portion consisting of a piece of continuous rod and/or metal strip of sufficient height to prevent cookware and/or food from sliding off while in use.

The cooking grill/tray has a top, bottom, a front edge, back edge, and right and left sides. The grill/tray has permanently affixed to it a round solid metal rod extending from the center of the back edge and turned downward at a 90° angle so as to fit into the aforesaid female grill/tray bracket sleeves affixed to the front of the vertical stake. The size of the said round rod affixed to and extending from the back edge of the cooking grill/tray is of the same diameter as the hole in the female bracket sleeve. When the grill/tray support rod is inserted into the hole of the female bracket sleeve which is attached to the vertical stake, the grill may be easily moved, and swiveled from side to side right to left 180° from the center of the vertical stake. This movement allows the user to further adjust and reposition the grill/tray over or away from the fire to facilitate a desired position while cooking and tending to food.

Accordingly, it is the principal object of the invention to provide a means whereby a food can be cooked over an open fire, including campfire, patio fire bowls and/or basins and fire rings, as well as, charcoal containers.

It is another object of the invention to provide a means of raising and lowering the cooking surface of the grill in relation to the fire to control the amount of food being prepared.

Still another object of the invention is to provide a cooking grill/tray surface that can be moved horizontally 180° to the right or left, side to side, as so to position said grill/tray either over or away from fire so that said food being prepared can be attended to more easily.

It is a further object of the invention to provide a means by which multiple grill/trays can be used simultaneously in various positions to facilitate food preparation and cooking.

Still another object of the invention, is to provide a cooking apparatus that has bracket sleeves on its top horizontal portion with which to hold additional grill/trays for holding utensils, cooking condiments, and accessories to facilitate the cooking process. These grill/trays can be quickly and easily removed, installed, raised, and lowered, and are able to be turned 360° as desired.

Additionally it is an object of the invention to provide improved elements and arrangements thereof in an apparatus for the purposes described which is inexpensive, dependable, and fully effective in accomplishing its intended purposes.

These and other objects of the present invention will become readily apparent upon further review of the following specifications and drawings.

### BRIEF DESCRIPTION OF THE DRAWINGS

FIG. 1 is a front view of the open fire multi-purpose cooking grill showing the vertical stake portion, the horizontal top portion, with reinforced strike plate, cooking grill/trays attached to the vertical stake by means of grill/tray support brackets and the bottom of said vertical stakes exhibiting the angled shape to produce a sharp edge to penetrate the ground.

FIG. 2 is a side view of the open fire multi-purpose cooking grill showing the vertical grill/tray support stake with support brackets attached thereto and with top horizontal member with grill/tray support bracket and strike plate. Also shown are the cooking grills/trays with round male rod connector bar extending from its back edge and down turned at 90° angle for insertion into the female support bracket sleeve attached to vertical support stake. Also shown is sharpened bottom portion of vertical support stake.

FIG. 3 is a perspective view of the open-fire multi-purpose cooking grill showing its top horizontal member with grill/tray mounted into bracket sleeves and the vertical grill/trays support stake with grill/trays attached at different levels by means of grill/tray attachment bracket sleeves permanently affixed to said vertical grill/tray support stake. Also shown is the sharp angular cut of bottom of said vertical said stake.

FIG. 4 is a top view of the open-fire multi-purpose cooking grill showing the top horizontal support member with grill/tray attached by means of grill/tray bracket sleeves to said member demonstrating pictorially the ability of said grill/tray to swivel 360°. Also shown is a grill/tray attached to the vertical grill/tray support stake by means of support bracket attached to said vertical member pictorially demonstrating it ability to be swiveled to the right and left sides 180°.

FIG. 5 is a prospective and cut away view of the optional base stand with two horizontal parallel bars connected by a cross bar placed between and perpendicular to said parallel bars. The cross bar supports a vertical tubing into which the vertical stake fits thereby holding and supporting said vertical stake while cooking.

FIG. 6 is a cut away view of the cooking grill/tray support bracket assembly consisting of male and female components and attached to front surface of vertical stake in the assembled position.

### DETAILED DESCRIPTION OF THE PREFERRED EMBODIMENTS

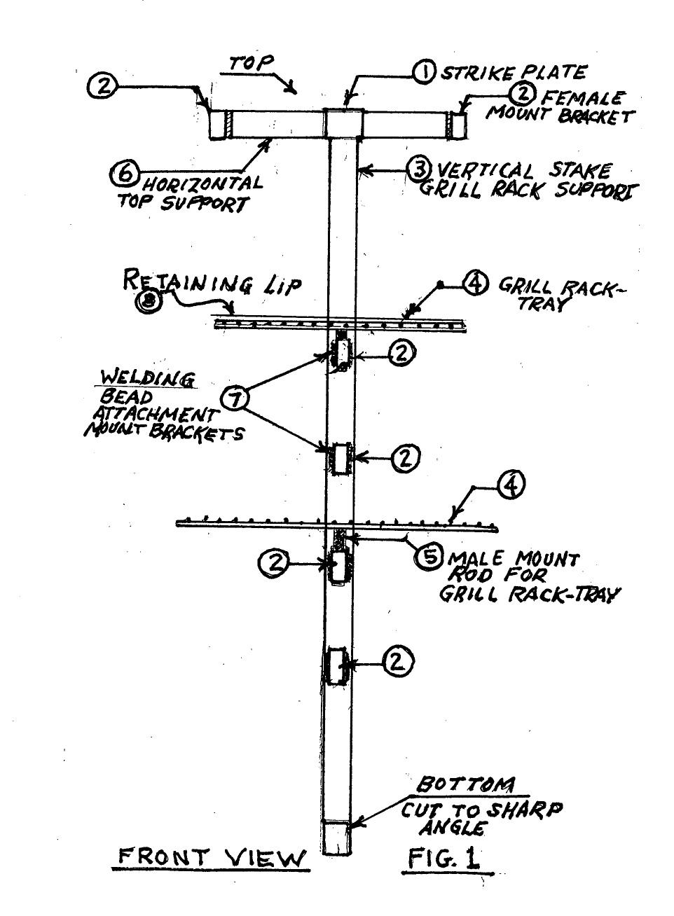

Referring to the drawings, FIG. 1 illustrates the open fire multi-purpose cooking grill of the present invention which is useful in many situations but specifically adapted to be used for cooking food over an open fire, be it a camp fire, fire-pit, fire-bowl, or fire basin, or any other such container to support an open fire or charcoal bed over which cooking of food may be accomplished properly.

The open fire multi-purpose cooking grill (A) generally comprises a vertical member (3) with a horizontal member (6) permanently affixed perpendicularly atop said vertical stake (3) having on each of two ends, female mounting sleeves (2) permanently affixed thereto. Vertical grill/tray support stake (3) has permanently attached to its front side female grill/tray mounting sleeves (2) at various positions spaced apart for the purpose of supporting the cooking grill/tray rack (4). The cooking grill tray rack (4) is attached to said vertical stake (3) by inserting solid male connector rod (5) extending from back side of rack and down turned at 90° angle that turned down portion of rod (5) inserted into female mounting sleeve (2) thus supporting said grill/tray rack (4) and allowing the grill/tray rack (4) to be swiveled from left to right, side to side up to 180° to facilitate handling of food during the cooking process.

Also shown in FIG. 1 is a strike plate (1) consisting of a metal plate permanently affixed to center top of vertical grill/tray support stake (3) which allows the user to strike the top of said vertical stake (3) with a mallet or hammer when driving said stake into the ground.

The open fire multi-purpose cooking grill (A) is constructed of metal and/or steel to provide strength and durability to support sometimes heavy pots, pans, skillets and various cookware and to withstand high temperatures near an open fire.

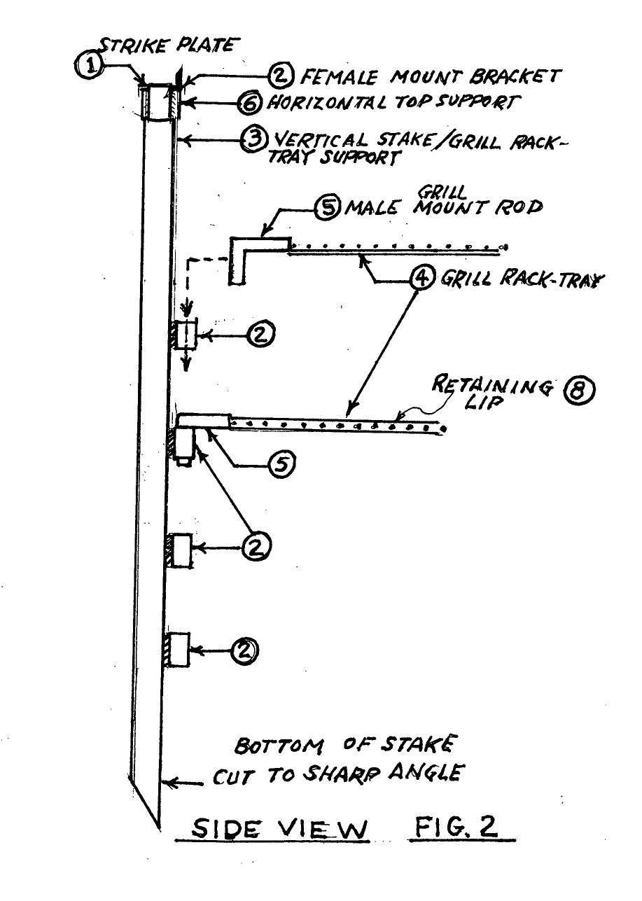

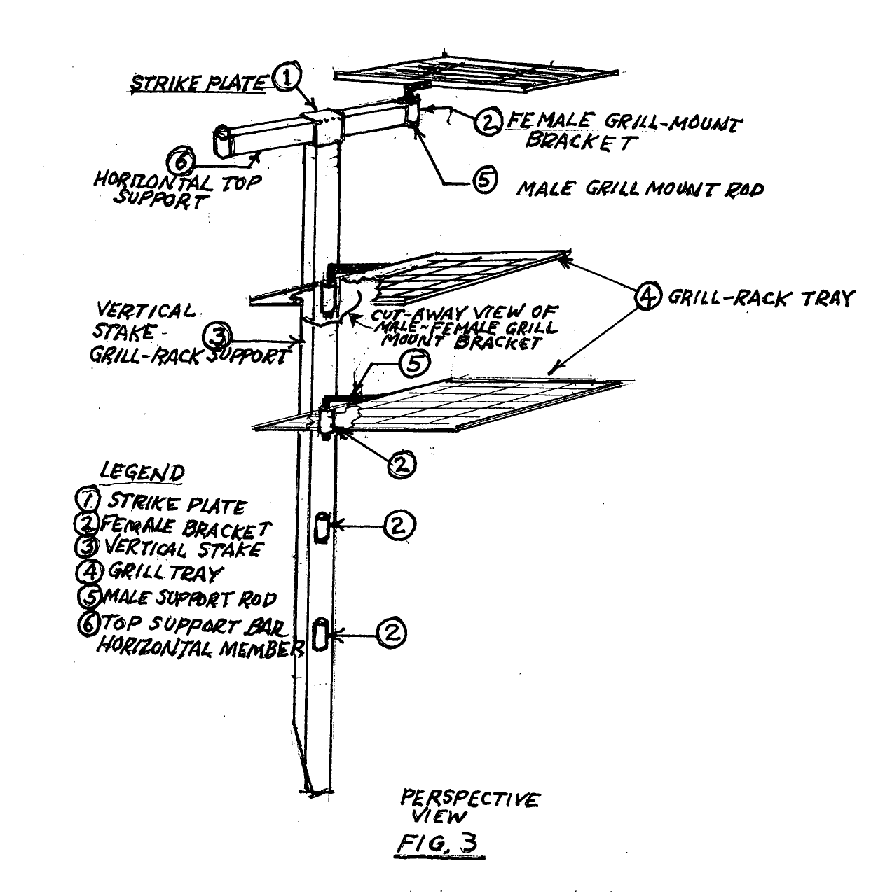

FIGS. 1, 2 and 3 show the bottom of the vertical stake (3) cut at an angle as to produce a sharp edge to aid in penetration of the ground.

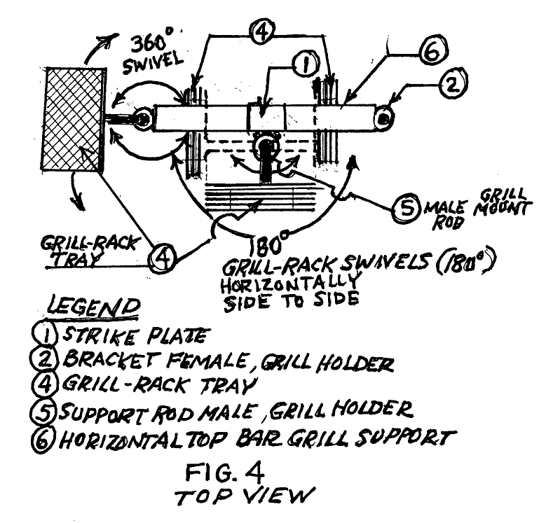

FIG. 4 is a top view which shows the horizontal member (6) with strike plate (1) with two female grill/tray mount sleeves (2) supporting grill/tray racks (4) which can be placed on to the said horizontal member (6) to hold various utensils, cookware, seasonings, sauces or other condiments as needed when cooking or preparing food.

FIG. 4 also shows the versatility of said cooking grill/tray rack assembly (4) having the ability to be swiveled into any horizontal plane position of 360° which is useful and convenient to user.

FIG. 4 pictorially demonstrates the top grill/rack tray versatility and the ability of the grill/rack tray (4) mounted on vertical stake (3) to be positioned at different elevations along said vertical stake to desired temperature. Also grill/tray rack (4) mounted to vertical stake (3) can be swiveled from side to side, left to right up to 180° to facilitate the cooking process and food handling.

FIGS. 1, 2, 3, 4 also demonstrates the further versatility of the open fire multi-purpose cooking grill by showing multiple grill/rack trays (4) being used simultaneously attached to the vertical stake (3) and additional grill/rack trays (4) attached to horizontal top support member (6). This feature is useful in preparing multiple food items requiring different cook times and temperatures enabling user to place food items closer to or further away from the open fire as needed.

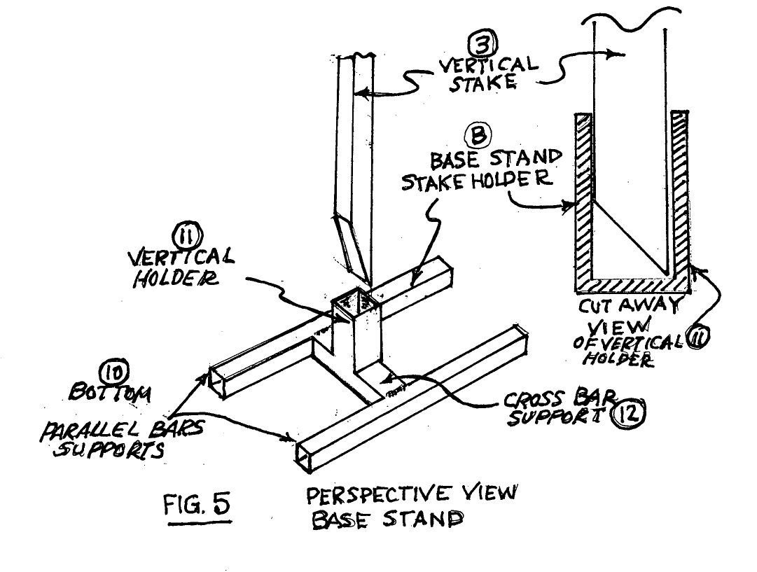

FIG. 5 shows optional base stand (B) with two horizontal bottom supports (10) a perpendicular crossbar support (12) and a vertical stake holder (11).

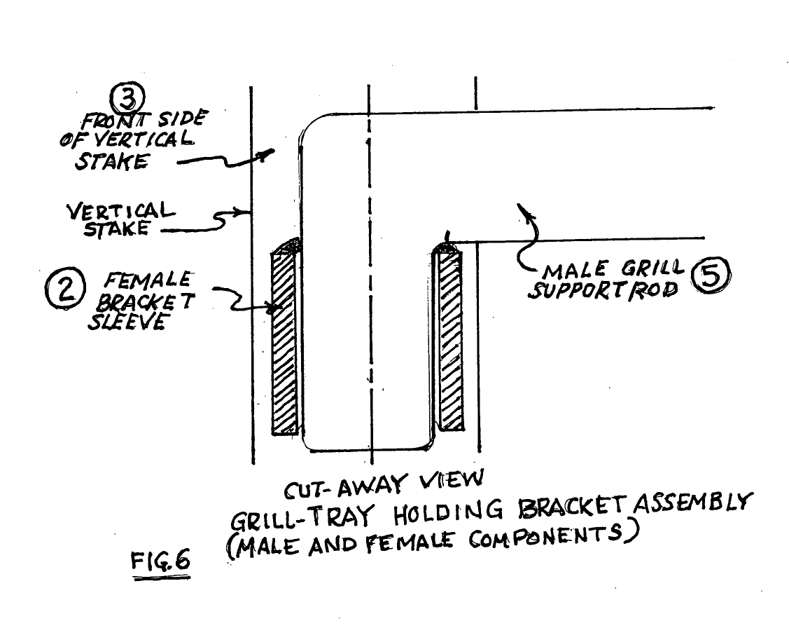

FIG. 6 shows cutaway view of assembled grill/tray bracket with female sleeve (2) and male support rod (5) mounted to vertical stake (3).

We claim:

1. an open fire multi-purpose cooking grill used by a person to cook food over an open fire and that is adapted to support multiple removable grills and or trays that can be swiveled, raised and lowered easily into different positions both either vertically and or horizontally during the food cooking preparation and cooking process, comprising of:
a “T” shaped vertical stake formed of metal and or steel having a top, bottom, front and back sides said stake to be driven into the ground or placed in base holder near an open fire to cook food.
a means of attaching cooking grills and or trays to said vertical stake to allow user to remove, replace, swivel and adjust said grills and or trays in different positions while cooking.

2. a cooking grill according to claim 1, having a “T” shaped vertical grill/tray support stake made of metal, having a top and bottom portion with front and back surface and both right and left sides. Said vertical stake is used to simultaneously support multiple cooking grill/trays and or food preparation trays/racks when driven into the ground or placed in base stand adjacent to an open fire for the purpose of cooking foods.

3. a cooking grill according to claim 2, with a metal horizontal support bar permanently affixed to top of said vertical stake with female grill/tray support sleeves permanently affixed thereto on each of two ends of said horizontal support.

4. a cooking grill according to claim 2, said vertical stake with multiple metal support sleeves permanently affixed to front edge of said vertical stake at different positions from top to bottom.

5. a cooking grill according to claim 4, with a female support sleeve consisting of a cylindrical hollow metal part of sufficient length placed parallel and permanently affixed to front surface of vertical support stake.

6. a cooking grill according to claim 2, with a solid round male support rod extending from rear edge of cooking grill/rack or tray and down turned at 90° angle so as to enable said male grill support rod to be inserted into female support sleeve for the purpose of supporting said cooking grill/tray and further enabling said grill to be swiveled from side to side left to right up to 180° while mounted to vertical support stake.

7. a cooking grill according to claim 2, with a vertical support stake which has a top and bottom with bottom portion being cut as to form a sharp edge to aid in penetration of the ground surface with a top member placed perpendicular thereto with support brackets.

8. a cooking grill according to claim 2, one or more cooking grill/trays consisting of flat square or rectangular surface made from heat resistant metal or steel rods spaced appropriately to hold food and or cookware containing food and around its perimeter of said grill/tray a raised part made from metal of sufficient height to prevent and or aid in the prevention of food or cookware sliding off said surface while cooking, additionally having a male support rod extending from rear edge of said grill/tray and down turned at an angle of 90° of sufficient diameter to fit snuggly into female bracket thereby enabling the user to conveniently install and remove said grill/tray on and off the vertical stake at different levels and swivel said grill/tray left and right from side to side 180° as needed in the food preparation and cooking process.

9. according to claim 1, a base stand for holding said cooking grill as an option when it is not possible to drive said vertical stake into the ground when using open fire multi-purpose cooking grill on patio or concrete slab, wooden deck or other such solid surfaces where driving said vertical stake into the ground is not an option and where furthermore the stand is made of steel and or metal of sufficient strength, weight and size as to provide good footing and support of said grill when in use with all grill/trays attached thereto and cookware and foods are placed on the grill in any of its various capable positions.
